(19) United States
(12) Patent Application Publication
(10) Pub. No.: US 2021/0290492 A1
(43) Pub. Date: Sep. 23, 2021

(54) Nursing simulator system for nursing an infant

(71) Applicant: Marcus Hires, Valrico, FL (US)

(72) Inventor: Marcus Hires, Valrico, FL (US)

(21) Appl. No.: 16/825,972

(22) Filed: Mar. 20, 2020

(51) Int. Cl. A61J 11/00; A61J 9/00; A61J 9/02; A01K 9/00

(52) U.S. Cl. CPC A61J 11/00; A01K 9/005; A61J 9/02; A61J 9/005

(57) ABSTRACT

A nursing simulator system, includes a nursing body with a torso and a plurality of limbs; an access panel; a bladder with nipple attachment points that protrude through apertures in the nursing body; nipples that attach to the nipple attachment points; and a thermostat controlled heating system with a heating element, a temperature display, and control buttons. The limbs are flexible and adjustable, such that the limbs are positionable to hold a nursing infant.

### CROSS-REFERENCE TO RELATED APPLICATIONS

N/A.

### FIELD OF THE INVENTION

The present invention relates generally to the field of nursing accessories for humans and pets, and more particularly to methods and systems for nursing simulators.

### BACKGROUND OF THE INVENTION

Third world countries, specifically Sub-Saharan Africa and Southern Asia, comprise 86% of the global maternal mortality rates. This equates to 254,000 maternal deaths annually, leaving newborns with higher mortality rates when not properly provided with nutritional supplements.

Novel solutions are needed to enable the children affected by maternal mortality to have a better chance of survival through controlled, sanitized and maintainable nutrition. With the assistance of global organizations such as the World Health Organization, the proper nutrition delivered to these orphaned children increases their success in thriving and developing into healthy children.

Additionally, there are mothers that suffer from lactation failure or have inadequate milk supply.

As such, considering the foregoing, it may be appreciated that there continues to be a need for novel and improved devices and methods for nursing simulator devices.

### SUMMARY OF THE INVENTION

The foregoing needs are met, to a great extent, by the present invention, wherein in aspects of this invention, enhancements are provided to the existing model of nursing simulator devices.

In an aspect, a nursing simulator system for nursing an infant can include:
a) a nursing body with a torso, which can include:
   i. a plurality of connector apertures; and
   ii. a plurality of limbs, which are attached to the torso;
   wherein the nursing body contains a feeding liquid;
b) a bladder, which contains a feeding liquid, wherein the bladder is positioned in the interior of the torso, wherein the bladder can include:
   a plurality of nipple attachment points, such that each nipple attachment point penetrates through a corresponding connector aperture in the plurality of connector apertures; and
c) a plurality of nipples, which detachably attach to the nipple attachment points, such that the nipples deliver the feeding liquid to the newborn, via fluid connections from the interior of the bladder;
d) a heating system, including:
   i. at least one heating element, which heats the nursing body, including the feeding liquid;
   ii. a temperature sensor;
   iii. a thermostat control unit, which controls a temperature of the nursing body;
   iv. a temperature display, which displays a current temperature measured by the temperature sensor;
   v. control buttons, which are configured to adjust a target temperature, such that the thermostat control unit maintains the target temperature.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1A is a front perspective view of a nursing simulator system, according to an embodiment of the invention.

FIG. 1B is a front perspective view of a nursing simulator system, according to an embodiment of the invention.

FIG. 1C is a front perspective view of a nursing simulator system, according to an embodiment of the invention.

FIG. 2A is a rear perspective view of a nursing simulator system, according to an embodiment of the invention.

FIG. 2B is a rear perspective view of a nursing simulator system, according to an embodiment of the invention.

FIG. 3A is a front perspective view of a nursing simulator system, according to an embodiment of the invention.

FIG. 3B is a front perspective view of a nursing simulator system, according to an embodiment of the invention.

FIG. 4 is a schematic diagram illustrating a heating system, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

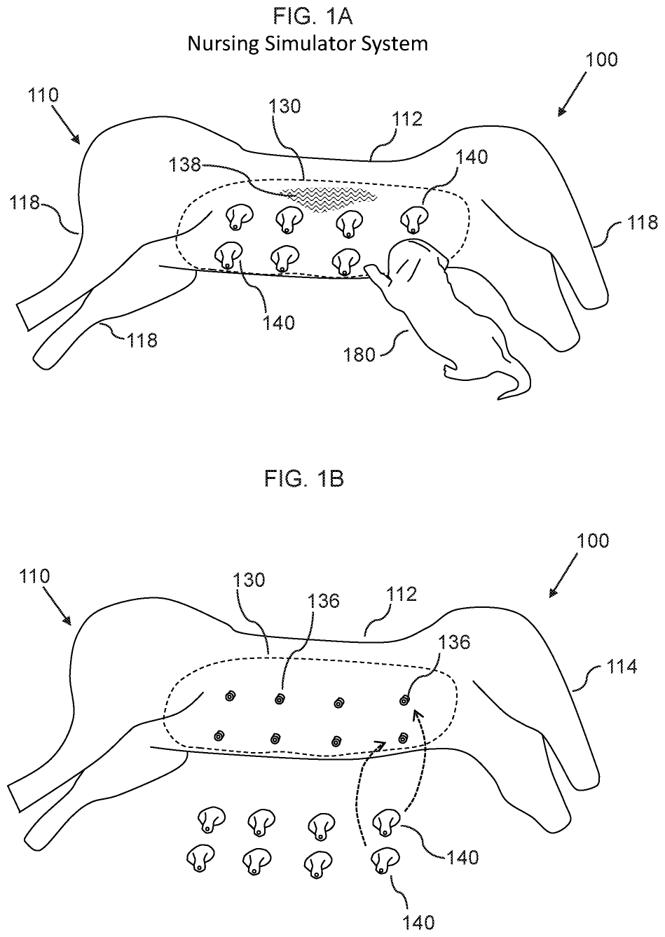

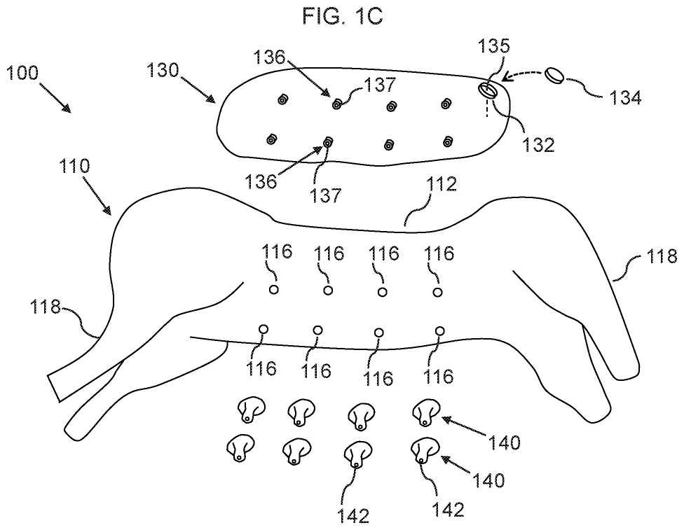

In the following, we describe the structure of an embodiment of a nursing simulator system 100 with reference to FIG. 1, in such manner that like reference numerals refer to like components throughout; a convention that we shall employ for the remainder of this specification.

This disclosure is intended to provide a nursing simulator system 100 for use in the event that a newborn is unable to be nursed by its natural mother. Through a design that represents the newborn's natural feeding environment, temperature-controlled fluid is delivered to the newborn providing necessary nutrients for growth.

The nursing simulator system 100 distributes temperature-controlled nutritional fluid for the purpose of nursing newborns, including human newborns and animal newborns.

The nursing simulator system 100 provides nutritional milk to newborns in the event the birth mother is incapable of nursing, for example due to medical reasons or death. By providing a nursing simulator system 100 that mimics the mother's shape, nipple and temperature, it is the intent to increase the survival chances of the newborn.

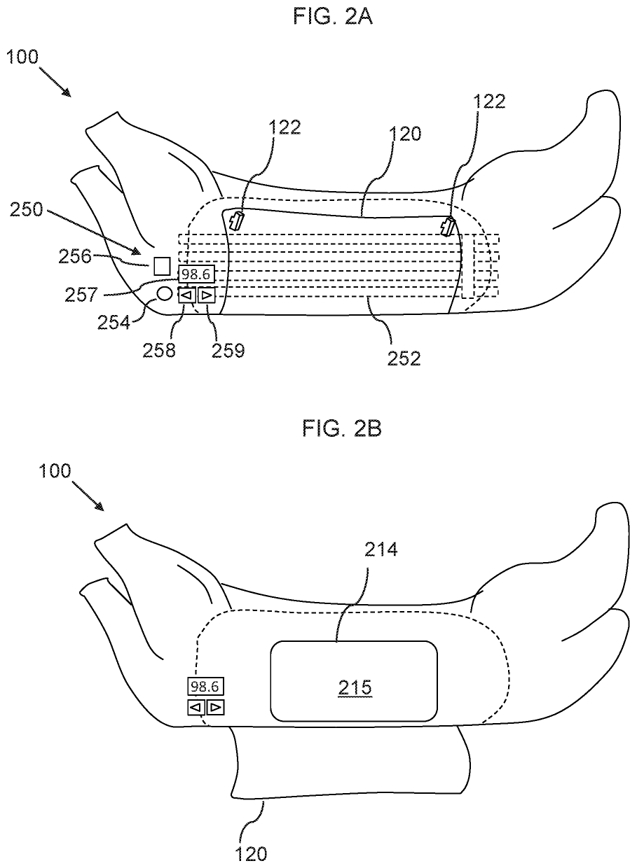

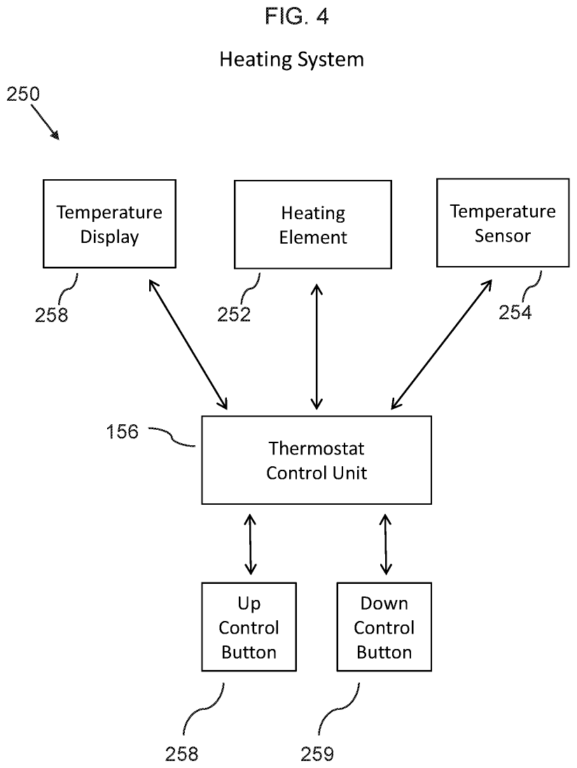

In an embodiment, as shown in FIG. 1A, 1B, 1C, 2A, and 2B, a nursing simulator system 100 for nursing an infant 180 (such as an infant human 180 or an infant animal 180) can include:
a) a nursing body 110, which can comprise:
   i. a torso 112, which comprises an opening 214, which provides access to an interior 215 of the torso 112, wherein the torso 112 comprises:
      a plurality of connector apertures 116, as shown in FIG. 1C; and
   ii. a plurality of limbs 118, which are attached to the torso 112;
   wherein the nursing body 110 is configured to contain a feeding liquid 138;
b) an access panel 120, as shown in FIG. 2A and 2B, which can be hingedly connected to a side of the opening 214, such that closing and opening the access panel 120 closes and opens access to the interior 215 of the torso 112, wherein the access panel 120 comprises:
   i. a plurality of panel locks 122, which are configured to releasably lock the access panel 120 in a closed configuration; and
c) a bladder 130, which is configured to contain a feeding liquid 138, wherein the bladder 130 is positioned in the interior 215 of the torso 112, wherein the bladder 130 includes:
   i. a bladder aperture 132, covered with a removable cap 134, such that a feeding liquid 138 can be poured into an interior 135 of the bladder 130 via the bladder aperture 132;
   ii. a plurality of nipple attachment points 136, such that each nipple attachment point 136 penetrates through a corresponding connector aperture 116 in the plurality of connector apertures 116; and
d) a plurality of nipples 140, which are configured to detachably attach to the nipple attachment points 136, wherein the nipples 140 are in fluid contact with the feeding liquid 138 inside the nursing body 110, such that each nipple 140 is detachably attached to a corresponding nipple attachment point 136, such that the nipples 140 deliver the feeding liquid to the newborn 180, via fluid connections from the interior 135 of the bladder 130 to exit apertures 142 of the nipples 140 via attachment apertures 137 of the nipple attachment points 136;
e) a heating system 250, as shown in FIG. 2A and 4, comprising:
   i. at least one heating element 252, which is configured to heat the nursing body 110, including the feeding liquid 138;
   ii. a temperature sensor 254;
   iii. a thermostat control unit 256, which is configured to control a temperature of the nursing body 110 in communication with the at least one heating element 252 and the temperature sensor 254, wherein the thermostat control unit 256 for example can be a control circuit or microcontroller;
   iv. a temperature display 257, which is configured to display a current temperature measured by the temperature sensor 254;
   v. up and down buttons 258, 259, which are configured to adjust a target temperature up and down respectively, such that the thermostat control unit 256 maintains the target temperature.

Thus, in a related embodiment, a nursing simulator system 100 for nursing an infant 180, can include:
a) a nursing body 110, which includes:
   i. a torso 112; and
   ii. a plurality of limbs 118, which can be two limbs 118, which are attached to the torso 112;
   wherein the nursing body is configured to contain a feeding liquid 138 in an interior 215 of the torso 112; and
b) at least one nipple 140, which includes an exit aperture 142, wherein the at least one nipple 140 is configured to detachably attach to the torso 112, such that the at least one nipple 140 is in fluid contact with the feeding liquid 138 in the interior 215 of the torso 112, such that the at least one nipple 140 delivers the feeding liquid 138 to the infant 180.

In a further related embodiment, the nursing simulator system 100 can further include:
a bladder 130, which is configured to contain the feeding liquid 138, wherein the bladder 130 is positioned in the interior 215 of the torso 112.

In a yet further related embodiment, the nursing simulator system 100 can further include:
at least one nipple attachment point 136, which is connected to a surface of the bladder 130, such that the at least one nipple attachment point 136 comprises an attachment aperture 137, which is in fluid connection with an interior 135 of the bladder 130;
wherein the at least one nipple 140 is detachably attached to the at least one nipple attachment point 136, such that the at least one nipple 140 delivers the feeding liquid to 138 the infant 180, via a fluid connection from the interior 135 of the bladder 130, via the attachment aperture 137 of the at least one nipple attachment point 136, to the exit aperture 142 of the at least one nipple 140.

In a further related embodiment, the torso 112 can further include:
at least one connector aperture 116 in a surface of the torso 112, such that the at least one nipple attachment point 136 penetrates through the at least one connector aperture 116.

In a related embodiment, an outer layer of the nursing body 110 can be made from an elastomer rubber, such as a silicone rubber, that provides flexibility, ease of maintenance and temperature control, to replicate a nursing mother's environment to the newborn. The elastomer surface can be marked or decorated to resemble an animal's fur and skin tone, or to resemble human skin.

In another related embodiment, the bladder 130 can be an FDA certified bag of a plastic material, which can be similar to plastic materials used in medical IV bags. The bladder 130 can be cleaned by opening the access panel 120, removing the nipples 140 from the front of the nursing body 110 and flushing with clean water.

In another related embodiment, the thermostat heating system 250 can be configured to provide a safe and desirable feeding liquid. The thermostat control unit 156 can be an integrated unit with an LED display 257 that reflects the current temperature of the feeding liquid held within the bladder. The temperature setting can be adjusted through two buttons 259 below the LED display 257, which can be either decreasing or increasing the temperature one degree at a time. The default setting can be 98.0 degrees. The heating system 250 including the thermostat control unit 256 can be waterproof and capable of withstanding exposure in nursing environments.

In another related embodiment, the nipples 140 can be configured to be interchangeable with industry products available on the market. This allows the user to select a specific size, texture or opening size; and also allows the user to remove the nipples 140 and disinfect them in the dishwasher.

In an embodiment, as shown in FIG. 1A, the nursing body 110 can be configured to resemble a four-legged animal, such as a dog or pig, such that the nursing body 110 is configured with four limbs 118, whereby the nursing simulator system 100 is configured for use by an infant animal 180, such as an infant dog, cat or pig.

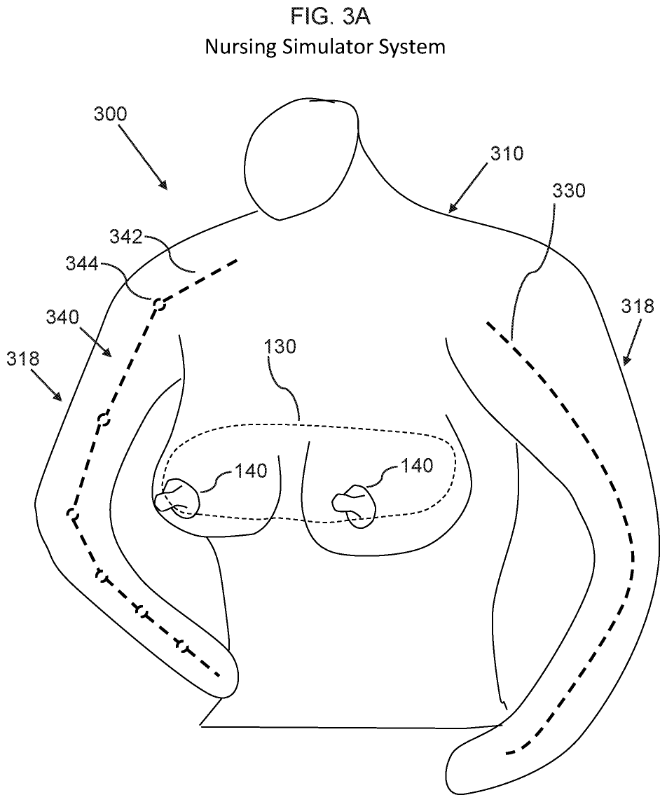

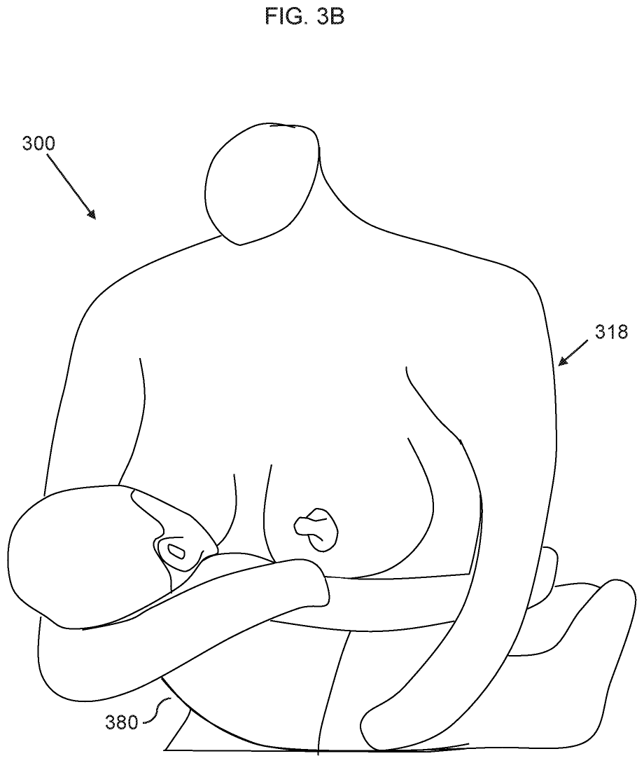

In an embodiment of a nursing simulator system 300, as shown in FIGS. 3A and 3B, the nursing body 310 can be configured to resemble an upper torso of a human female, such that the nursing body 110 is configured with two limbs 318, which are configured to resemble two human arms 318 (which may or may not include hands and fingers), whereby the nursing simulator system 300 is configured for use by an infant human 380.

In a further related embodiment, the limbs 118, 318 can be configured to be flexible and adjustable, such that the limbs can be positioned (i.e. are positionable) to hold a nursing infant 180. The limbs 118, 318 can for example, as shown in FIG. 3A, each be configured with an internally mounted flexible elongated structure 330, which can be an internally mounted flexible and bendable metal rod 330 made from a soft metal or alloy, or the limbs can be configured with an internal flexible adjustable shaft 330 similar to shafts used in gooseneck lamps, or the limbs can be configured with an internal flexible adjustable shaft 340 configured with shaft segments 342 connected by flexible adjustable joints 344, which can for example be ball joints 344.

Here has thus been described a multitude of embodiments of the nursing simulator system 100, 300, and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

Many such alternative configurations are readily apparent, and should be considered fully included in this specification and the claims appended hereto. Accordingly, since numerous modifications and variations will readily occur to those skilled in the art, the invention is not limited to the exact construction and operation illustrated and described, and thus, all suitable modifications and equivalents may be resorted to, falling within the scope of the invention.

What is claimed is:

1. A nursing simulator system for nursing an infant, comprising:
a) a nursing body, which comprises:
a torso; and
a plurality of limbs, which are attached to the torso;
wherein the nursing body is configured to contain a feeding liquid in an interior of the torso; and
b) at least one nipple, which comprises an exit aperture, wherein the at least one nipple is configured to detachably attach to the torso, such that the at least one nipple is in fluid contact with the feeding liquid in the interior of the torso, such that the at least one nipple delivers the feeding liquid to the infant.

2. The nursing simulator system of claim 1, further comprising:
an access panel;
wherein the torso comprises an opening, which provides access to the interior of the torso; wherein the access panel is hingedly connected to a side of the opening, such that closing the access panel closes access to the interior of the torso, and opening the access panel opens access to the interior of the torso.

3. The nursing simulator system of claim 1, further comprising:
a bladder, which is configured to contain the feeding liquid, wherein the bladder is positioned in the interior of the torso.

4. The nursing simulator system of claim 3, further comprising:
at least one nipple attachment point, which is connected to a surface of the bladder, such that the at least one nipple attachment point comprises an attachment aperture, which is in fluid connection with an interior of the bladder;
wherein the at least one nipple is detachably attached to the at least one nipple attachment point, such that the at least one nipple delivers the feeding liquid to the infant, via a fluid connection from the interior of the bladder, via the attachment aperture of the at least one nipple attachment point, to the exit aperture of the at least one nipple.

5. The nursing simulator system of claim 4, wherein the torso further comprises:
at least one connector aperture in a surface of the torso, such that the at least one nipple attachment point penetrates through the at least one connector aperture.

6. The nursing simulator system of claim 1, further comprising:
a heating system, comprising at least one heating element, which is configured to heat the feeding liquid and the nursing body.

7. The nursing simulator system of claim 6, wherein the heating system further comprises:
a) a temperature sensor; and
b) a thermostat control unit, which is configured to control a temperature of the nursing body in communication with the at least one heating element and the temperature sensor.

8. The nursing simulator system of claim 7, wherein the heating system further comprises:
a) a temperature display, which is configured to display a current temperature measured by the temperature sensor; and
b) up and down buttons, which are configured to adjust a target temperature up and down respectively, such that the thermostat control unit maintains the target temperature.

9. The nursing simulator system of claim 1, wherein the plurality of limbs is four limbs, and wherein the nursing body is configured to resemble a four-legged animal.

10. The nursing simulator system of claim 1, wherein the plurality of limbs is two limbs, and wherein the nursing body is configured to resemble an upper torso of a human female.

11. The nursing simulator system of claim 1, wherein an outer layer of the nursing body is made from an elastomer rubber.

12. The nursing simulator system of claim 11, wherein the elastomer rubber is a silicone rubber.

13. The nursing simulator system of claim 1, wherein each limb in the plurality of limbs is configured to be flexible and adjustable, such that the limbs are positionable to hold the infant.

14. The nursing simulator system of claim 13, wherein each limb in the plurality of limbs comprises an internally mounted flexible elongated structure.

15. A nursing simulator system for nursing an infant, comprising:
a) a nursing body, which comprises:
a torso; and
two limbs, which are attached to the torso;
wherein the nursing body is configured to contain a feeding liquid in an interior of the torso; and
b) at least one nipple, which comprises an exit aperture, wherein the at least one nipple is configured to detachably attach to the torso, such that the at least one nipple is in fluid contact with the feeding liquid in the interior of the torso, such that the at least one nipple delivers the feeding liquid to the infant.

16. The nursing simulator system of claim 15, further comprising:
a bladder, which is configured to contain the feeding liquid, wherein the bladder is positioned in the interior of the torso.

17. The nursing simulator system of claim 16, further comprising:
at least one nipple attachment point, which is connected to a surface of the bladder, such that the at least one nipple attachment point comprises an attachment aperture, which is in fluid connection with an interior of the bladder;
wherein the at least one nipple is detachably attached to the at least one nipple attachment point, such that the at least one nipple delivers the feeding liquid to the infant, via a fluid connection from the interior of the bladder, via the attachment aperture of the at least one nipple attachment point, to the exit aperture of the at least one nipple.

18. The nursing simulator system of claim 15, further comprising:
a heating system, comprising at least one heating element, which is configured to heat the feeding liquid and the nursing body.

19. The nursing simulator system of claim 15, wherein the nursing body is configured to resemble an upper torso of a human female.

20. The nursing simulator system of claim 15, wherein each limb of the two limbs is configured to be flexible and adjustable, such that the two limbs are positionable to hold the infant.
